(19) United States
(12) Patent Application Publication
(10) Pub. No.: US 2024/0300059 A1
(43) Pub. Date: Sep. 12, 2024

(54) WELLBORE GUN BUILDER WITH GUN CHUCKS AND METHOD OF USING SAME

(71) Applicant: GR Energy Services Management, LP, Sugar Land, TX (US)

(72) Inventors: Cameron Michael Bryant, Sugar Land, TX (US); James William ANTHONY, Missouri City, TX (US); David Chesney, Houston, TX (US); Roma Montifar, Katy, TX (US); Tyler Chaney, Rosharon, TX (US); Andres C Villareal, Duncanville, TX (US); David M Headley, Manvel, TX (US); Joel R. Henry, Manvel, TX (US)

(73) Assignee: GR Energy Services Management, LP, Sugar Land, TX (US)

(21) Appl. No.: 18/271,439

(22) PCT Filed: Jan. 9, 2022
(86) PCT No.: PCT/US2022/011739

§ 371 Date: Jul. 7, 2023

Related U.S. Application Data
(60) Provisional application No. 63/135,610, filed on Jan. 9, 2021.

(51) Int. Cl. B23P 19/04; E21B 43/116; E21B 43/119

(52) U.S. Cl. CPC B23P 19/04; E21B 43/116; E21B 43/119

(57) ABSTRACT

A wellbore gun assembly includes a chuck assembly for assembling a wellbore gun. The chuck assembly includes a chuck housing, a rotating gun chuck, and an axial gun chuck. The gun chucks have chuck jaws radially movable about a hole in the gun chucks to selectively grip a portion of the wellbore gun. The holes of the gun chucks are aligned to define a passage for receiving the wellbore gun therethrough. The rotating gun chuck is rotationally positioned about the axial gun chuck to selectively rotate the portion of the wellbore gun as the axial gun chuck moves axially about the axial gun chuck whereby the portions of the wellbore gun are threadedly connected together. The chuck assembly also includes a gantry loader loads gun components onto a feed assembly, and the feed assembly feeds gun components into the chuck assembly.

### CROSS-REFERENCE TO RELATED APPLICATIONS

This application claims the benefit of U.S. Patent Application No. 63/135,910 entitled “Wellbore Gun Builder with Gun Chucks and Method of Using Same” filed on Jan. 9, 2021, the entire contents of which is hereby incorporated by reference herein to the extent not inconsistent with the present disclosure.

### BACKGROUND

The present disclosure relates generally to oilfield technology. More specifically, the present disclosure relates to devices for assembling wellbore equipment, such as perforating guns.

Wellsite operations are performed to locate and access subsurface targets, such as valuable hydrocarbons. Drilling equipment is positioned at the surface and downhole drilling tools are advanced into the subsurface formation to form wellbores. Once drilled, casing may be inserted into the wellbore and cemented into place to complete the well. Once the well is completed, production tubing may be deployed through the casing and into the wellbore to produce fluid to the surface for capture.

During the wellsite operations, various downhole tools, may be deployed into the earth to perform various procedures, such as measurement, perforation, injection, plugging, etc. Examples of downhole tools are provided in US Patent/Application Nos. 1020/0024935; 10507433; 10,036,236; 2020/0072029; US2020/0048996; 2016/0115753; 2020/0277837; 20190376775; 20190330947; 20190242222; 20190234189; 10309199; 20190127290; 20190086189; 20180299239; 20180224260; 9915513; 20180038208; 9822618; 9605937; 20170074078; 9581422; 20170030693; 20160356132; 20160061572; 8960093; 20140033939; 8267012; 6520089; 20160115753; 20190178045; and 10365079, the entire contents of which is hereby incorporated by reference herein to the extent not inconsistent with the present disclosure.

These downhole tools are made of multiple components that are pre-assembled in workshops and delivered to wellsites, or assembled at the wellsite. Examples of assembly techniques are provided in U.S. Pat. No. 7,896,083; 9,206,675; and 9,581,422, the entire contents of which is hereby incorporated by reference herein to the extent not inconsistent with the present disclosure.

Despite the advancements in downhole technology, there remains a need for techniques for reliably, efficiently, and precisely assembling wellbore tools. The present disclosure is directed at providing such needs.

### SUMMARY

In at least one aspect, the present disclosure relates to a wellbore gun builder, comprising: a feed assembly and a chuck assembly. The feed assembly comprises a conveyor assembly and a linear actuator. The chuck assembly comprises a rotating gun chuck, an axial gun chuck, and chuck jaws.

In another aspect, the present disclosure relates to a method of building a wellbore gun, comprising: feeding gun components of the wellbore gun along a feed assembly and into a build assembly; and selectively connecting the gun components of the wellbore gun with chucks of the build assembly. The method may involve feeding a first gun carrier, a gun sub, and a second gun into a chuck assembly with the gun sub positioned between the first gun carrier and the second gun carrier, gripping the first gun carrier with an axial gun chuck of the chuck assembly, gripping the second gun carrier with a rotating gun chuck of the chuck assembly, and securing the gun sub to the first gun carrier and the second gun carrier by: applying a torque to rotate rotating gun chuck; and allowing the axial gun chuck to move axially about the rotating gun chuck.

In at least one aspect, the present disclosure relates to a chuck assembly for assembling a wellbore gun. The chuck assembly comprises a chuck housing, a rotating gun chuck, and an axial gun chuck. The rotating gun chuck is positioned in the chuck housing and rotationally movable thereabout. The rotating gun chuck has a first hole therethrough. The rotating gun comprises chuck jaws radially movable about the first hole in the rotating chuck to selectively grip a portion of the wellbore gun. The axial gun chuck is positioned in the chuck housing and axially movable thereabout, the axial gun chuck having a second hole therethrough. The axial gun chuck comprises chuck jaws radially movable about the second hole in the axial gun chuck to selectively grip another portion of the wellbore gun. The second hole of the axial gun chuck aligned with the first hole of the rotating gun chuck to define a passage for receiving the wellbore gun therethrough. The rotating gun chuck is rotationally positioned about the axial gun chuck to selectively rotate the portion of the wellbore gun as the axial gun chuck moves axially about the chuck housing whereby the portion of the wellbore gun is threadedly connected to the another portion of the wellbore gun.

In another aspect, the disclosure relates to a wellbore gun builder for assembling a wellbore gun. The wellbore gun builder comprises the chuck assembly as in claim 1; and a feed assembly comprising a conveyor positioned about the chuck assembly to selectively feed the wellbore gun through the passage.

In yet another aspect, the disclosure relates to a method of building a wellbore gun. The method comprises feeding gun components of the wellbore gun into a build assembly by: feeding a first gun, a gun sub, and a second gun into a chuck assembly with the gun sub positioned between the first gun and the second gun; gripping the first gun with an axial gun chuck of the chuck assembly; and gripping the second gun with a rotating gun chuck of the chuck assembly. The method further comprises: selectively connecting the gun components of the wellbore gun with the build assembly by: applying a torque to rotate the rotating gun chuck; and allowing the axial gun chuck to move axially about the rotating gun chuck.

This Summary is not intended to be limiting and should be read in light of the entire disclosure including text, claims and figures herein.

### BRIEF DESCRIPTION OF THE DRAWINGS

So that the above recited features and advantages of the present disclosure can be understood in detail, a more particular description of the invention, briefly summarized above, may be had by reference to the embodiments thereof that are illustrated in the appended drawings. The appended drawings illustrate example embodiments and are, therefore, not to be considered limiting of its scope. The figures are not necessarily to scale and certain features, and certain views of the figures may be shown exaggerated in scale or in schematic in the interest of clarity and conciseness.

FIGS. 1A and 1B are schematic views of a wellbore gun builder housed within a gun trailer.

FIG. 2A is a schematic front view of the wellbore gun builder and a wellbore gun, the wellbore gun builder including a feed assembly and a build assembly. FIG. 2B is a schematic rear view of the wellbore gun builder.

FIGS. 3A-3C are perspective, detailed, and exploded views, respectively of the feed assembly.

FIGS. 4A-4C are left perspective, front perspective, and exploded views, respectively, of the build assembly.

FIGS. 5A and 5B are schematic views of a portion of the build assembly depicting gun chucks in a retracted and extended position, respectively.

FIGS. 6A-6E are schematic views of the wellbore gun builder performing a gun building operation.

FIG. 7 is a flow chart depicting a method of building a wellbore gun.

FIG. 8 is a schematic view of the wellbore gun builder with a gantry loader housed within another gun trailer.

FIGS. 9A and 9B are schematic views of the wellbore gun builder with a gantry loader.

FIG. 10 is a detailed schematic view of the gantry loader.

FIG. 11 is a flow chart depicting a method of performing a gun building operation.

### DETAILED DESCRIPTION

The description that follows includes exemplary apparatus, methods, techniques, and/or instruction sequences that embody techniques of the present subject matter. However, it is understood that the described embodiments may be practiced without these specific details.

This disclosure relates to a wellbore gun builder for building (or assembling) a wellbore gun. The wellbore gun builder includes a feed assembly for transporting the wellbore gun and/or its gun components during building, and a build assembly for securing the gun components of the wellbore gun together. The build assembly may have gun chucks with chuck jaws for gripping and connecting together the gun components of the wellbore gun. The wellbore gun builder may also have a loader (e.g., transporter, lifter, crane, fork lift, gantry loader, etc.) for transporting and/or loading tool components onto the feed assembly.

The wellbore gun builder may have features intended to optimize building and performance of the wellbore gun. The feed assembly and/or the build assembly may be configured with optimized position parameters (e.g., alignment, orientation, dimensions, etc.) and/or operation parameters (e.g., feed rate, grip diameter, rotating speed, applied torque, impact force, driving rate, positioning, etc.) to facilitate assembly. The gun, feed, build, and/or load assemblies may be pre-set and programmed to build specifications pre-defined for certain wellbore guns, gun builder equipment, facilities, materials, tolerances, etc. The wellbore gun builder may also be provided with devices, such as sensors, monitors, databases, gauges, alarms, lifts, inputs, outputs, controllers, actuators, computers, cameras, etc., capable of facilitating operation of the wellbore gun builder (e.g., to automate, measure, monitor, and/or control gun building operations).

The wellbore gun builder may also have safety features capable of monitoring operations, detecting safety conditions, and/or adjusting operations as needed to assure the wellbore gun builder performs according to pre-defined specifications (e.g., client instructions, pre-set operating conditions, safety guidelines, etc.) Monitored conditions may be used to collect building parameters (e.g., measured position parameters and/or operation parameters) of the wellbore gun and/or the wellbore gun builder during a build operation.

The wellbore gun builder and methods described herein are also intended to provide one or more of the following, among others: quick assembly, precise assembly, efficient assembly, simplified operation, repeatable placement, automated or semi-automated staging and/or assembly, equipment loading (manual, semi-automatic, or automatic), multiple assembly operations for building one or more wellbore guns (separately or in combination), programmable options, quick cycling of wellbore guns, on or offsite assembly and/or pre-assembly, monitoring and/or sensing capabilities, measurement of wellbore gun parameters (e.g., position, operation, etc.), ability to generate equipment records, equipment and/or inventory tracking, enhanced equipment reliability, reduction in cost, flexibility of use, time savings, efficient operation, reduced maintenance costs, transportability, etc.

‘Wellbore gun’ as used herein refers to a perforating gun deployable into a wellbore for perforating (or launching charges into) the wellbore. Examples of perforating guns are described in US Patent Application No. 2020/0072029, previously incorporated by reference herein.

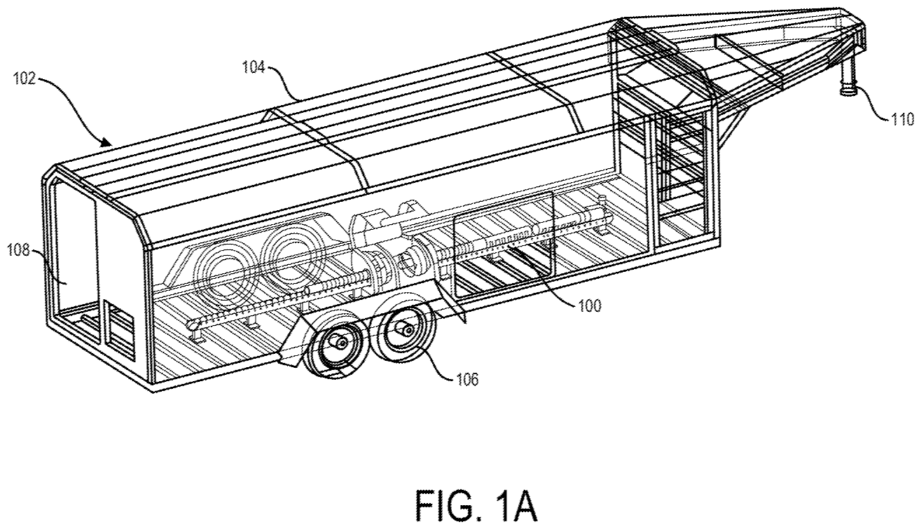

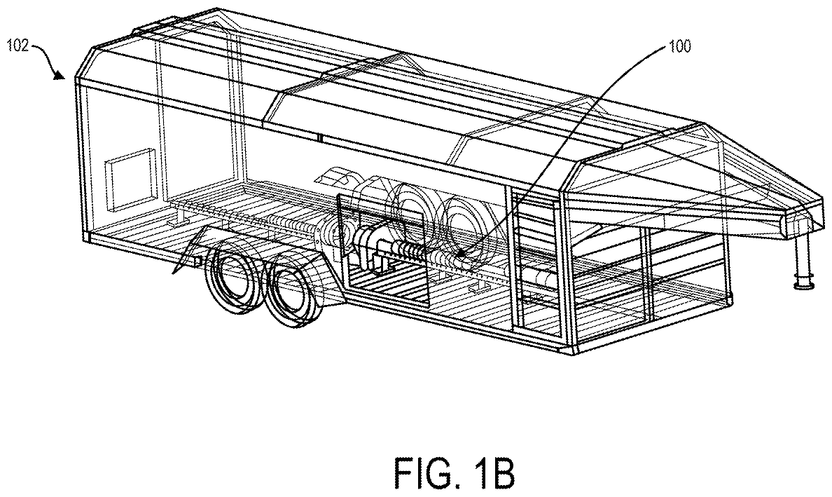

FIGS. 1A and 1B are schematic diagrams depicting a wellbore gun builder 100 housed within a gun trailer 102. The gun trailer 102 may be used to house, protect, and transport the wellbore gun builder 100. As shown in these views, the trailer 102 is a mobile unit including a frame 104 movably supported on a wheel assembly 106. The frame 104 has a hitch 110 connectable to a vehicle (not shown) for driving the gun trailer 102 to various locations. The gun trailer 102 may be transported to onsite locations at a wellsite, or offsite locations a distance therefrom.

The frame 104 is shaped to enclose and support the wellbore gun builder 100 therein. The frame 104 may have doors 108 and/or other access points for passing the wellbore gun builder 100 and allowing operators (not shown) to enter and use the wellbore gun builder 100. The frame 104 may also support storage of equipment, gun components, etc.

While FIGS. 1A and 1B depict the wellbore gun builder 100 inside the gun trailer 102, the wellbore gun builder 100 may be located anywhere. For example, the wellbore gun builder 100 may be located at a wellsite and/or an offsite location for building the wellbore guns as is described further herein. Also, while the gun builder 100 is shown being carried by a gun trailer 102 towed by the vehicle (not shown), the gun builder 100 may be a stationary unit or transported by various types of carriers and/or vehicles.

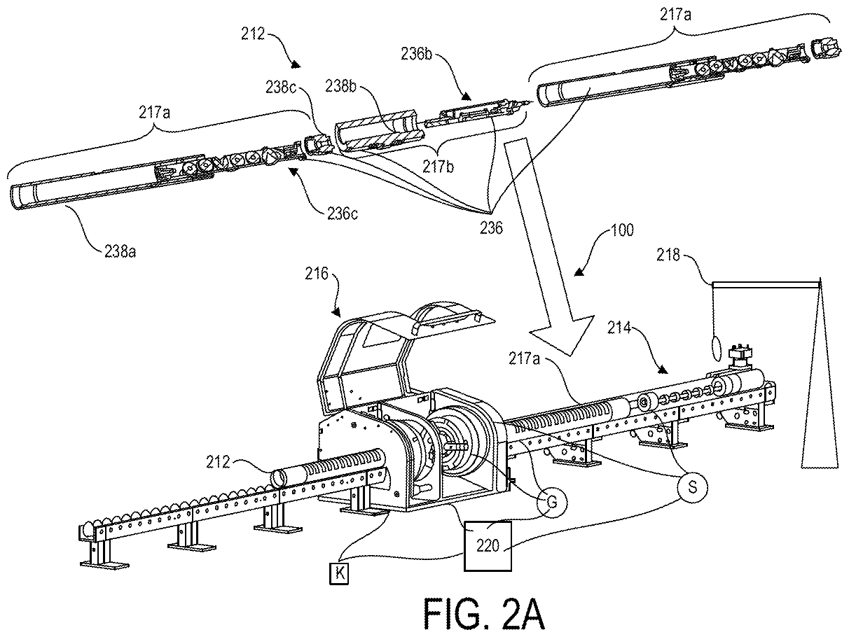

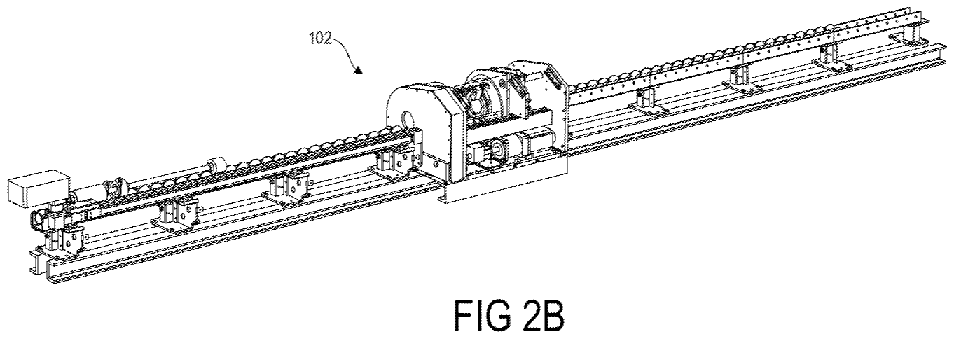

FIGS. 2A and 2B show views of the wellbore gun builder 100. FIG. 2A is a schematic front view of the wellbore gun builder 100 and a wellbore gun (or perforating unit) 212, the wellbore gun builder 100 including a feed assembly 214 and a build assembly 216. FIG. 2B is a schematic rear view of the wellbore gun builder 100. The wellbore gun builder 100 may be used to assemble various wellbore guns 212, such as the wellbore guns 212 shown in FIG. 2A. In this example, the wellbore gun 212 is shown as including two gun carriers 217a with a gun sub 217b therebetween. As also shown in the example of FIGS. 2A and 2B, each of the wellbore guns 212 includes a perforator housing 238a, a charge assembly 236c, a retainer 238c, a detonator assembly 236b, and support sub 238b, collectively referred to as gun components 236. Examples of perforating units and gun components are described in US Patent Application No. 2020/0072029, previously incorporated by reference herein.

In preparation for transport into the build assembly 216, the gun components 236 of the wellbore guns 212 may be placed on the feed assembly 214. The gun components 236 may be transported to and/or from the feed assembly 214 by a loader 218 capable of transporting, lifting, and/or loading the gun components 236 into the feed assembly 214. In the example shown, the loader 218 is as a crane. The loader 218 may also be, for example, a gantry (as described further herein) or other means (e.g., a forklift or an operator (not shown)). Once on the feed assembly 214, the gun components 236 are advance by the feed assembly 214 into the build assembly 216 for connection therein.

Prior to placement on the feed assembly 214 or while on the feed assembly 214, one or more of the gun components 236 of the wellbore gun 212, such as the gun carrier 217a and the gun sub 217b, may be pre-assembled. For example, the detonator assembly 236b may be pre-installed into the support sub 238b to form the gun sub 217b, and the charge assembly 236c and the retainer 238c may be pre-installed into the perforator housing 238a to form the gun carrier 217a. In another example, the gun sub(s) 217b may be pre-threaded onto the gun carrier 217a in preparation for building by the build assembly 216.

The gun components 236 of the wellbore gun 212 may be advanced into the build assembly 216 by the feed assembly 214. Once the wellbore gun 212 is built by the build assembly 216, the wellbore gun 212 may be passed from the build assembly 216 by the feed assembly 214. The feed assembly 214 may be configured to facilitate transport of the wellbore gun 212 and/or the gun components 236 to and from the build assembly 216 as is described further herein.

While FIGS. 2A and 2B show the wellbore gun builder 100 building a wellbore gun 212 including two gun carriers 217a and one gun sub 217b, the wellbore gun builder 100 may be used to assemble one or more separate wellbore guns 212. The wellbore gun builder 100 may also be used to build the wellbore gun 212 with various gun components 236, such as two or more gun carriers 217a with gun subs 217b therebetween. The wellbore gun 212 may also include additional gun components 236, such as additional gun carriers 217a, additional gun subs 217b, setting tools, plugging tools, electronics subs, or other downhole tools.

The wellbore gun builder 100 may also be provided with electronics 220 as schematically shown. These electronics 220 may include electronic devices, such as sensors, monitors, gauges, alarms, lifts, inputs, outputs, databases, controllers, actuators, computers, etc., capable of facilitating operation of the wellbore gun builder 100 (e.g., to automate, measure, monitor, and/or control gun building operations). For example, such electronics 220 may be coupled to the feed assembly 214 to selectively position, align, advance, and/or to cycle the gun components 236 about the build assembly 216 for building. In another example, the electronics 220 may be coupled to the build assembly 216 for selectively placing the build assembly 216 at appropriate dimensions for assembling the wellbore gun 212, and/or for selectively operating the build assembly 216 during building.

The electronics 220 may employ sensors S and/or gauges G to measure and/or monitor operations, and alarms to detect and alert as needed. The sensors S and gauges G may be positioned about the feed assembly 214 and the build assembly 216 to provide feedback to the electronics 220 as schematically shown. The electronics 220 may also employ controllers, such as limit switches, pressure valves, drivers, central processing units, etc., to allow for automatic or semi-automatic operation, safety reactions, and/or to make adjustments as needed. Input/output of the electronics 220 (and/or the sensors S and gauges G) may allow operators to set specifications, generate reports, and/or track operations.

In an example, the electronics 220 may continuously monitor operating conditions by gathering measurements and detecting the build assembly 216 and/or the wellbore guns 212 therein to assure proper operation. Proper operation may include, for example, operating according to client instructions, pre-defined specifications, safety guidelines (e.g., RP67 guidelines), etc. Continuous monitoring may involve, for example, monitoring various alert conditions, such as stray voltages, alarms, detected blockages/openings, and shutdowns. For example, where the chuck assembly 216 is opened during operation, the sensor (S) may detect building parameters, such as the open condition and/or an alarm may be set off. The alarm may alert an operator to manually kill power, or may automatically activate a power kill switch K to shut down the chuck assembly.

The electronics 220 may be used to set, measure, monitor, and/or adjust the gun builder 100 to operate according to optimized position parameters (e.g., alignment, orientation, dimensions, etc.), operation parameters (e.g., feed rate, grip diameter, rotating speed, applied torque, etc.), and/or pre-defined specifications. The electronics 220 may maintain a database of pre-defined and programmed specifications pre-defined for certain wellbore guns, gun builder equipment, facilities, materials, tolerances, etc. Electronic and/or communication signals may be sent to/from the electronics 220 to capture and detect monitored parameters, and send alarms, alerts, and/or control signals in response thereto. The electronics 220 may be used to allow manual and/or automatic adjustment by operators and/or computer programs to optimize operations.

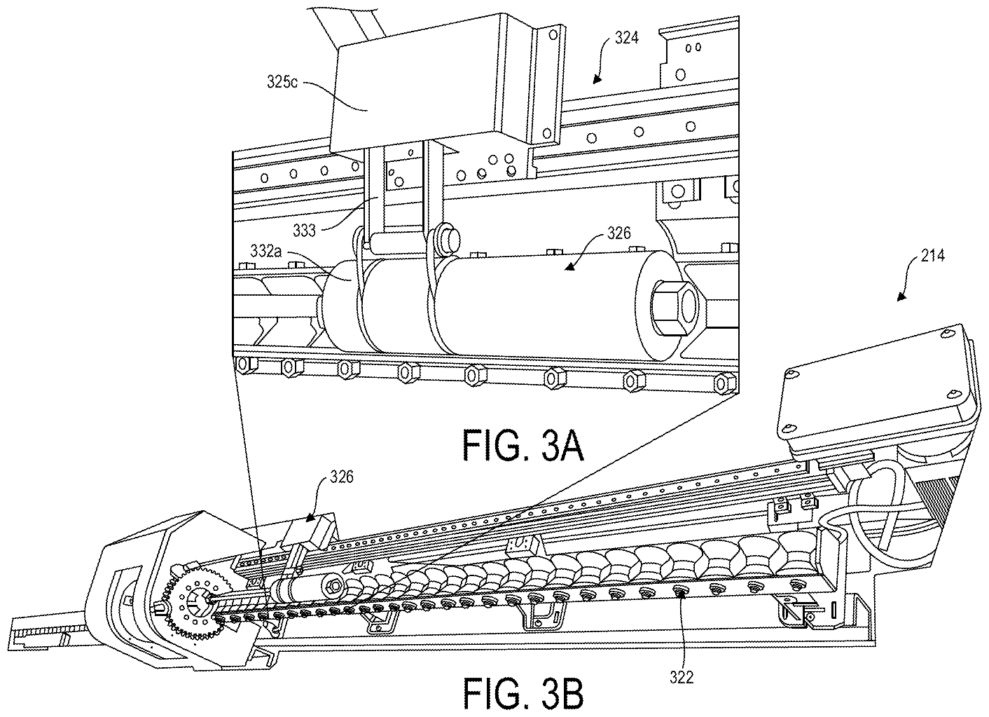

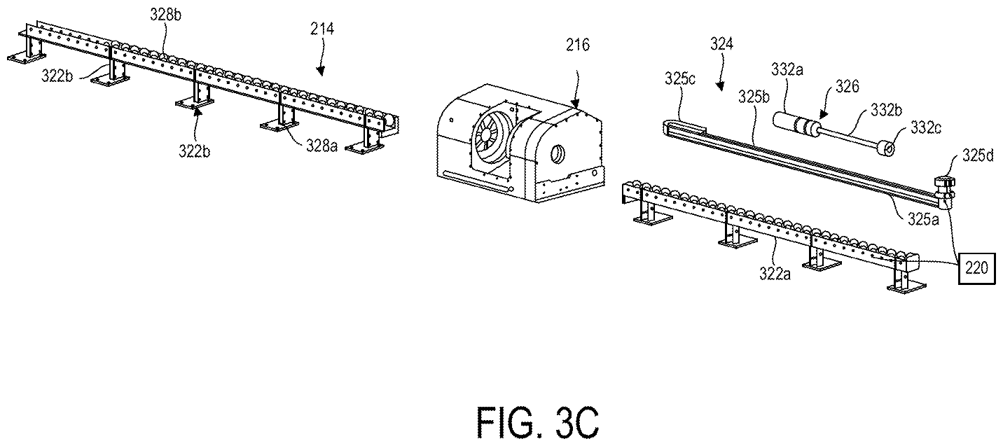

FIGS. 3A-3C are perspective, detailed, and exploded views, respectively of the feed assembly 214. The feed assembly 214 includes a conveyor 322, a linear actuator 324, and a drive assembly 326. The conveyor 322 may include an upstream portion 322a upstream of the build assembly 216 and a downstream portion 322b downstream of the build assembly 216.

Each of the upstream and downstream portions 322a,c of the conveyor 322 may include a frame 328a positioned about the build assembly 216. The frame 328a is supported on the ground with rollers 328b rotationally supported on the frame 328a. The rollers 328b are positioned along a top of the frame 328a in a configuration shaped for receiving, supporting, and slidingly passing the gun components 236 and/or the wellbore gun 212 therealong.

The conveyor 322 may optionally be powered and/or controlled by the electronics 220 (FIG. 2A) to adjust its positioning and operation for optimal feeding of the gun components 236 into the build assembly 216. The conveyor 322 may be manually or automatically adjusted to facilitate feeding of the gun components 236 of the wellbore gun 212 (FIG. 2A) into the build assembly 216 for assembly therein. For example, the conveyor 322 may be adjustably positioned at a desired height, angle, orientation, and/or other position parameter. In another example, the conveyor 322 may also be adjustably operated to selectively feed the gun components 236 at a desired rate, spacing, cycling, and/or other operation parameter.

As shown in FIGS. 3A-3C, the linear actuator 324 may be positioned on or adjacent to the conveyor 322. The linear actuator 324 includes a rail bracket 325a, a belt 325b, a carrier 325c, and a driver 325d. The rail bracket 325a is connectable to the frame 328a. The belt 325b is movably positionable along the rail bracket 325a. The belt 325b may be rotationally supported on pulleys or rollers (not shown) for rotation about the rail bracket 325a. The carrier 325c is secured to and carried by the belt 325b. The carrier 325c is also slidably connected to the rail bracket 325a for axial movement therealong. As the belt 325b is cycled, the carrier 325c rides along the rail bracket 325a.

The driver 325d of the linear actuator 324 may be a motor electronically connected to the linear actuator 324 to drive the belt 325b and the carrier 325c between positions. The driver 325d may be used to selectively drive the belt 325b, the carrier 325c, and/or the drive assembly 326, and thereby the gun components 236, to a desired position about the feed assembly 214 and the build assembly 216. The driver 325d may be coupled to the electronics 220 (FIG. 2A) and activated thereby to selectively move the belt 325b, the carrier 325c, and/or the drive assembly such that the gun components 236 is moved to desired positions along the conveyor 322. After passing through the build assembly 216 and after completion of assembly therein, the assembled wellbore gun 212 may pass continue along the downstream portion 322b of the conveyor 322.

The drive assembly 326 may include a cylinder 332a, a piston 332b, and a piston head 332c. The cylinder 332a may be positioned at one end of the piston 332b and the piston head 332c may be positioned at an opposite end of the piston 332b. As shown in FIG. 3B, the cylinder 332a is connected by a feed bracket 333 to the carrier 325c for movement therewith. The feed bracket 333 supports the cylinder 332a on the rollers 328b for slidable movement therealong as the carrier 325c slides along the rail bracket 325a. The cylinder 332a and/or the rollers 328b may be shaped (e.g., curved) to receive and movably support the cylinder 332a thereon.

The piston 332b may be a rod extending axially from the cylinder 332a and parallel to the conveyor 322 and the belt 325b. The piston 332b may be carried by the cylinder 332a as it is moved by the carrier 325c. The piston 332b may also be slidably movable about the cylinder 332a for extension and/or retraction therefrom. The cylinder 332a may be pressurized for dampening (or cushioning) the piston 332b as it moves about the cylinder 332a.

The piston head 332c may be carried by the piston 332b for movement therewith. The piston head 332c may be shaped for engagement with the gun components 236 positioned along the conveyor 322. The piston head 332c may contact an end of the gun components 236 and push the gun components 236 along the conveyor 322 as the piston 332b moves about the cylinder 332a and/or as the cylinder 332a move with the carrier 325c. The piston head 332c may push the gun components 236 to a desired position about the build assembly 216. The cushioned movement between the piston 332b and the cylinder 332a may dampen contact between the piston head 332c and the gun components 236.

The drive assembly 326 may be coupled to the electronics 220 and/or the driver 325d for selective operation therewith. For example, the electronics 220 (FIG. 2A) may be used to adjust a pressure of the cylinder 332a and/or movement of the piston 332b relative thereto, thereby adjusting operation parameters, such as the impact force, driving rate, and/or positioning of the gun components 236 about the conveyor 322. The drive assembly 326 may also be configured for use with specific gun components 236, conveyors 322, and/or linear actuators 324.

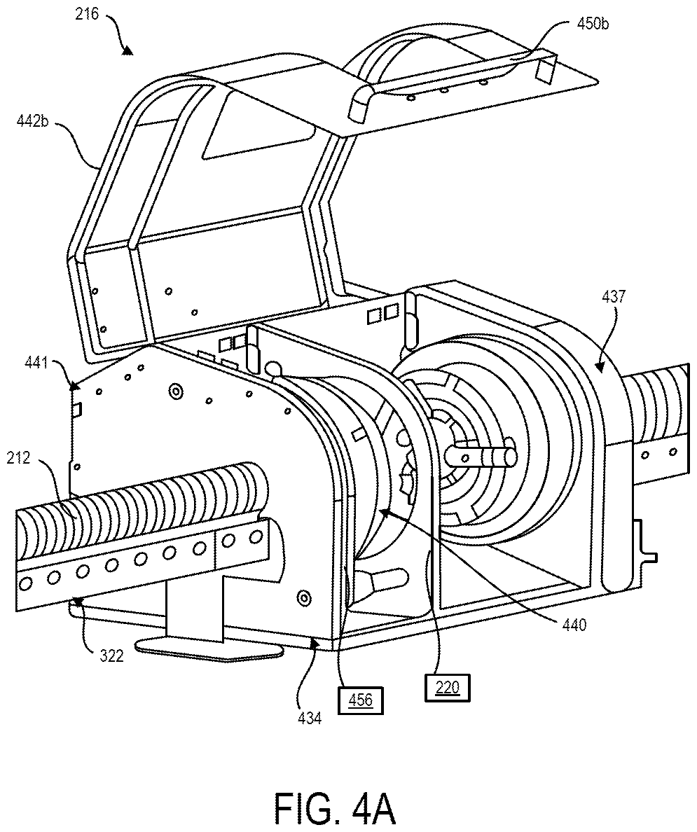

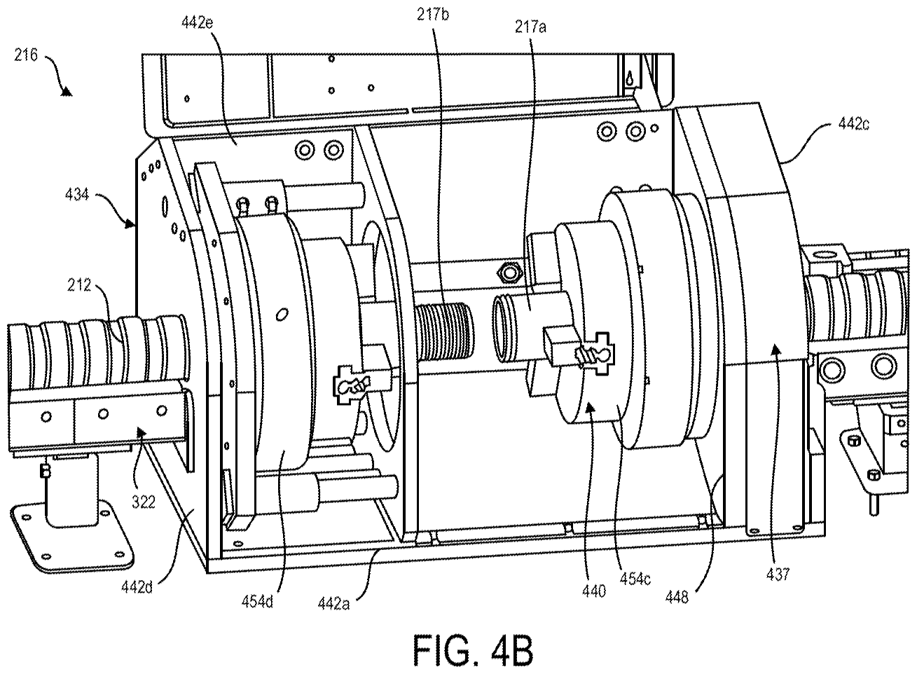

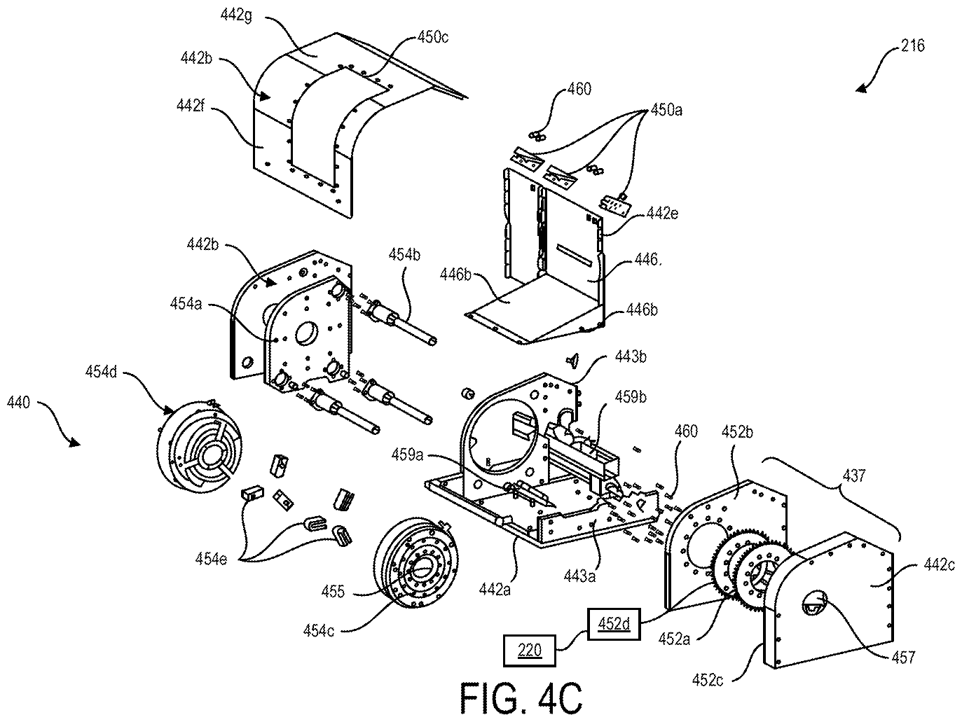

FIGS. 4A-4C are left perspective, front perspective, and exploded views, respectively, of the build assembly 216. As shown by these figures, the build assembly 216 is configured to receive, engage, position, and connect the gun components 236 (e.g., gun sub 217b and gun carrier 217a) to form the wellbore gun 212. As also shown in these views, the build assembly 216 includes a chuck housing 434, a gear assembly 437, and a chuck assembly 440. The chuck housing 434 is supported about the conveyor 322. The chuck housing 434 is shaped to enclose the gear assembly 437 and the chuck assembly 440 therein, as well as portions of the wellbore gun 212 during connection.

The chuck housing 434 includes a base 442a, a lid 442b, an upstream side 442c, a downstream side 442d, and a back side 442e. The base 442a, upstream side 442c, downstream side 442d, and back side 442e form a case 441 with the lid 442b movable about the case 441 for providing access therein. The base 442a may be supported on a floor or a distance above the floor in alignment with the conveyor 322. The base 442a has a gear plate 443a and a chuck plate 443b positioned thereon. The base 442a and the gear plate 443a are parallel to each other, and are perpendicular to the base 442a. The gear plate 443a extends a distance above an upstream end of the base 442a adjacent to the gear assembly 437. The chuck plate 443b is positioned a distance from the gear plate 443a and extends a greater distance above the base 442a. The chuck plate 443b is shaped to support portions of the chuck assembly 440 as is described further herein.

The upstream side 442c and the downstream side 442d are vertical plates connected to opposite ends of the base 442a, and extend vertically above the base 442a. The upstream side 442c and the downstream side 442d are parallel to each other, and perpendicular to the base 442a. The upstream side 442c is connected to the gear plate 443a and may act as a vertical support (or mounting plate) for the gear assembly 437. The downstream side 442d is connected to a downstream end of the base 442a. The downstream side 442d may act as a vertical support (or mounting plate) for the chuck assembly 440 as is described further herein.

The back side 442e is an L-shaped member connected to and extending a distance above the base 442a. The back side 442a has a vertical portion 446a and a ramp portion 446b. The vertical portion 446a extends vertically from a back edge of the base 442a with the ramp portion 446b extending onto an upper surface of the base 442a. The ramp portion 446b extends perpendicularly from the vertical portion 446a a distance above a bottom edge thereof. The ramp portion 446b has an angled surface that tapers downward away from the vertical portion 446a and to a front edge of the base 442a.

The lid 442b may be a curved member shaped to enclose the base 442a, the upstream side 442c, the downstream side 442d, and the back sides 442e to define a chuck chamber 448 therein. The lid 442b may extend from the back side 442e, along the upstream and downstream sides 442c,d and to the base 442a to define a front side 442f and a top 442g of the chuck housing 434.

The lid 442b may be provided with hinges 450a, a handle 450b, and a window 450c. The hinges 450a may pivotally connect the lid 442b to the back side 442e for movement between an open and a closed position. The handle 450b may be positioned on an outer surface of the lid 442b to facilitate opening and closing. The window 450c may be an opening that extends through the lid 442b for access into, and/or may be provided with glass for visibility into the chuck chamber 448.

The gear assembly 437 includes gears 452a rotationally supported between the upstream side 442c and the gear plate 452b. The gear plate 452b may be parallel to the upstream side 442c and connected a distance therefrom along the base 442a to define a gear chamber 452c therebetween for housing the gears 452a. The upstream side 442c may be provided with flanged edges shape to engage the gear plate 452b and enclose the gear chamber 452c. Two of the gears 452a are shown, but any number of gears may be provided and driven by a motor 452d as schematically shown. The electronics 220 may be used to selectively activate the motor 452d and/or the gears 452a to operate the chuck assembly 440 as is described further herein.

The chuck assembly 440 may include a bearing plate 454a, the chuck plate 443b, bearings 454b, a rotating (upstream) gun chuck 454c, an axial (downstream) gun chuck 454d, and chuck jaws 454e. The chuck assembly 440 may be provided with other features, such as connectors 460, sensors S (FIG. 2A), drivers (motor 452d), the electronics 220, etc.

The bearing plate 454a may be positioned between the downstream side 442d and the chuck plate 443b. The bearings 454b may include three linear ball bearings positioned along bearing shafts. The bearings 454b may be connected to the bearing plate 454a and the chuck plate 443b to define a pocket to receive the axial gun chuck 454d therein.

Each of the gun chucks 454c,d is ring shaped member positioned a distance from each other and facing each other. Each of the gun chucks 454c,d have a hole 455 shaped to receive the gun components 236 (FIG. 2A) therethough. The rotating gun chuck 454c is rotationally mounted to the chuck plate 443b and the axial gun chuck 454d is axially mounted to the bearing plate 454a.

Each of the gun chucks 454c, d has chuck jaws 454e mounted to a face thereof. The chuck jaws 454e are radially positioned about the hole 455 in each of the gun chucks 454c,d. The chuck jaws 454e are positioned on each of the axial gun chuck 454d and movable thereabout to receivingly engage an outer diameter of the gun components 236. The axial gun chuck 454d may be connected to a fluid source (e.g., compressed air) 456 for pneumatically activating the axial gun chucks 454d to shift the chuck jaws 454e between open and closed positions as is described further herein.

The build assembly 216 may have other features, such as axial guides 459a,b for supporting the axial gun chuck 454d during operation. The axial guide 459a is positioned on the base 442a and the axial guide 459b is supported on the back side 442e. The axial guide 459a may include a pair of piston/cylinders that extend and retract with the axial gun chuck 454d as it moves axially. The axial guide 459a may be a telescoping rail that expands and contracts as the axial gun chuck 454d moves axially about the build assembly 216.

The gear assembly 437, the sides 442c,d, the bearing plate 454a, and the chuck plate 443b have corresponding openings defining a passage 457 to receive the wellbore gun 212 (and/or the gun components 236) therethrough. These openings may have an inner diameter that is shaped and sized to allow the wellbore gun 212 to pass therethrough. The holes 455 of the chuck assembly 440 are also positioned along the passage 457 to receive the wellbore gun 212 therethrough.

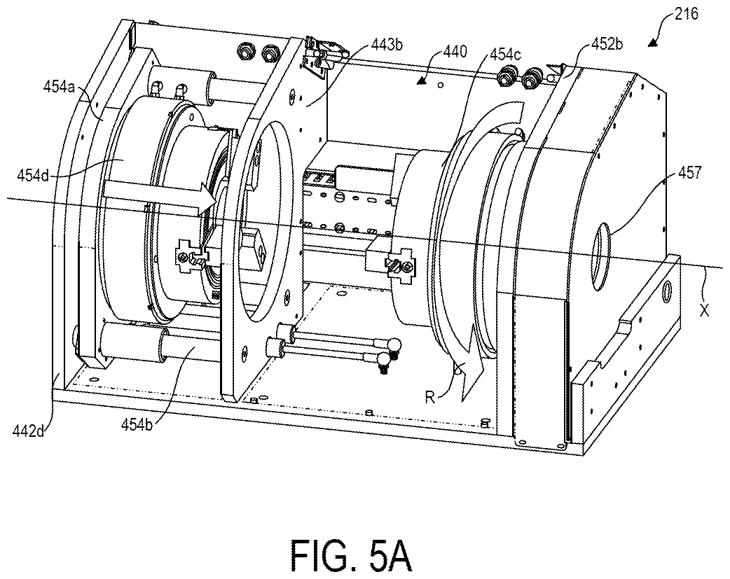

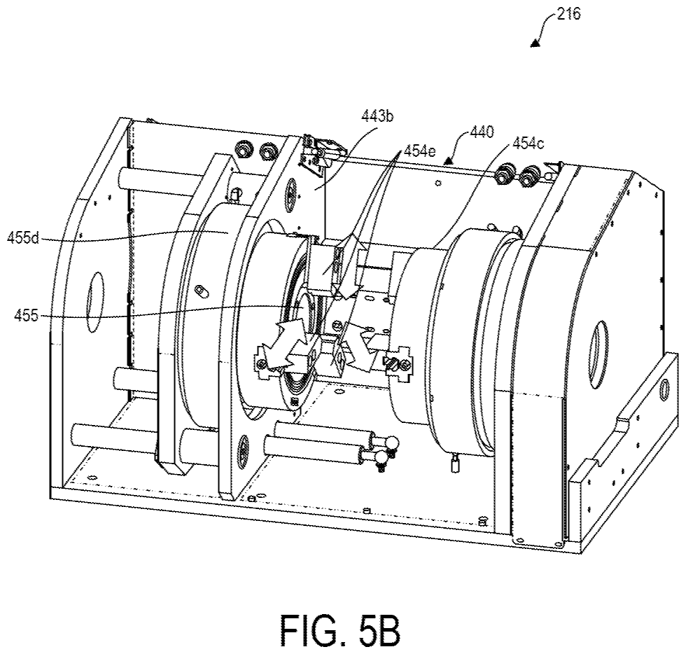

FIGS. 5A and 5B demonstrate movement of the chuck assembly 440. FIGS. 5A and 5B are schematic views of a portion of the build assembly 216 depicting the gun chucks 454c,d in a retracted and extended position, respectively.

The rotating gun chuck 454c is rotationally movable about the gear plate 452b by the gears 452a (FIG. 4C). The axial gun chuck 454d and the bearing plate 454a are axially movable by the bearings 454b from a retracted position in FIG. 5A adjacent the downstream side 442d to an extended position in FIG. 5B adjacent the chuck plate 443b. The rotating gun chuck 454c may be limited to rotational motion R about an X axis as indicated by the curved arrow, and the axial gun chuck 454d may be limited to axial motion along the X axis as indicated by the linear arrow in FIG. 5A.

The chuck jaws 454e are movable about the gun chucks 454c,d to selectively grip and release the gun components 236 during operation. Each of the chuck jaws 454e may move linearly between a grip position adjacent to the hole 455 and an ungrip position a distance from the hole 455 as shown by the three arrows in FIG. 5B.

The build assembly 216 may operate according to pre-defined specifications. The pre-defined specifications may be set stored in databases and access for manual or automatic setup and/or operation using the electronics 220 (FIG. 4A). For example, the build assembly 216 may optionally have fixed diameter holes, replaceable parts, and/or adjustable parts for use with specific wellbore guns 212. The build assembly 216 may also build the wellbore gun 212 according to predefined operation parameters. For example, the build assembly 216 may have a predefined grip diameter for gripping the gun components 236 with the chuck jaws 454e, rotational speed for rotating the rotating gun chuck 454c, and applied torque for driving the rotating gun chuck 454c.

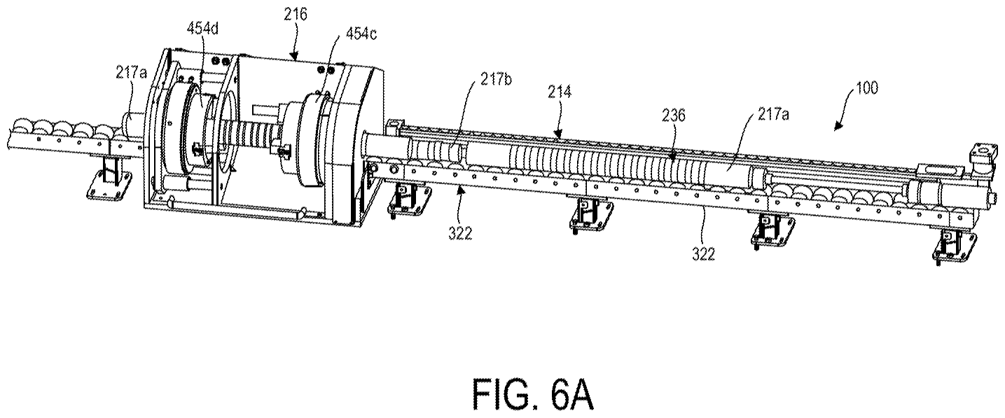

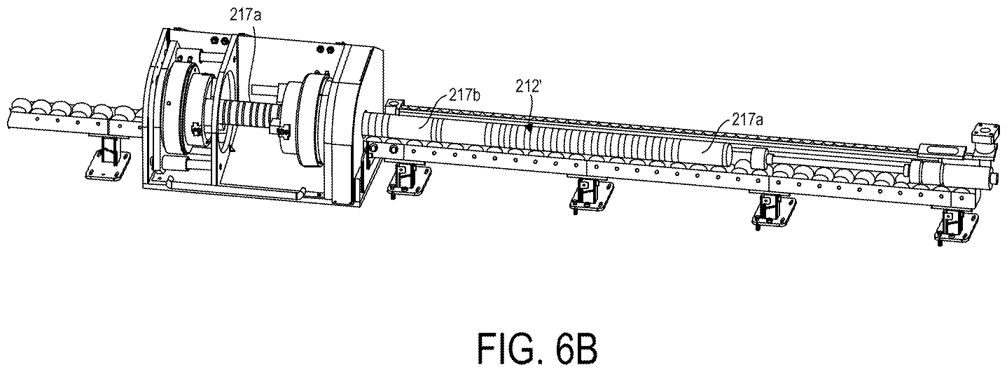

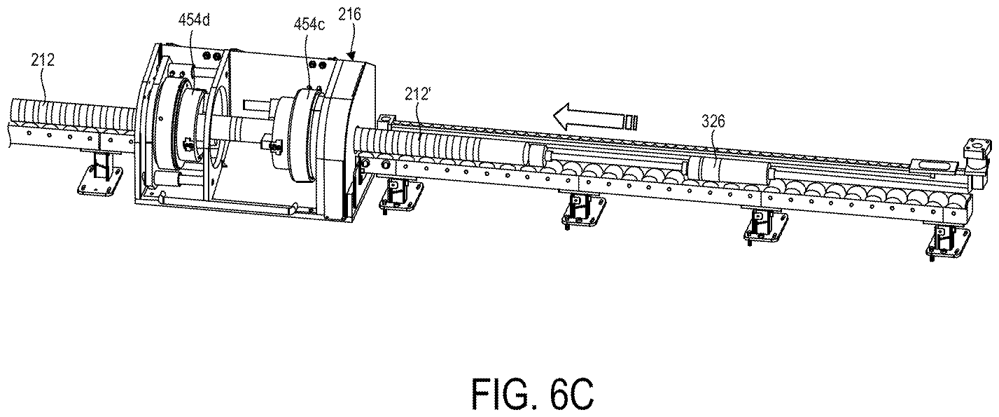

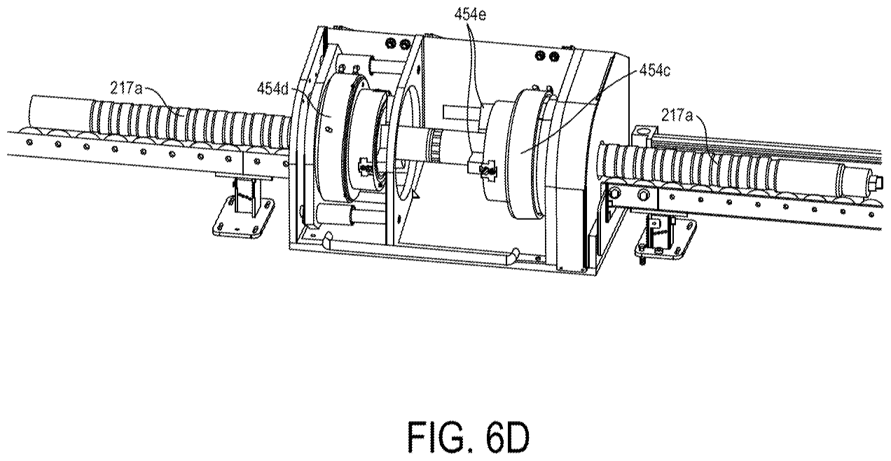

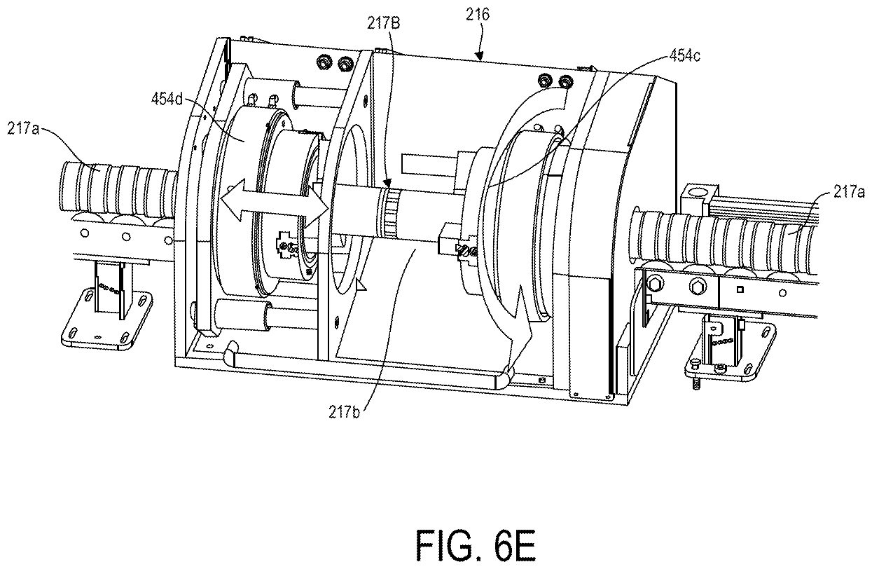

FIGS. 6A-6E are schematic views of the wellbore gun builder 100 performing a gun building operation. As demonstrated by these figures, by selectively activating the rotating gun chuck 454c and the axial gun chuck 454d, the gun components 236 are gripped and moved in a manner that threadedly connects and optimally secures the gun components 236 together to form the wellbore gun 212.

These views show a first gun carrier 217a, a gun sub 217b, and a second gun carrier 217a cycled through the wellbore gun builder 100 to form the wellbore gun 212. As shown in FIG. 6A, a first gun carrier 217a and a second gun carrier 217a are positioned on the upstream portion 322a of the conveyor 322 with the gun sub 217b therebetween. As shown in FIG. 6B, initially, the first gun carrier 217a and the second gun carrier 217a may be manually threaded to opposite ends of the gun sub 217b to form a pre-threaded wellbore gun 212′. This pre-threaded wellbore gun 212′ may be threaded together to facilitate movement through the build assembly 216 and/or to facilitate threading by the gun chucks 454c,d.

As shown in FIG. 6C, the drive assembly 326 may be activated to drive the pre-assembled wellbore gun 212′ (or the separate gun components 236) into the build assembly 216. The drive assembly 326 is positioned to engage an end of the pre-assembled wellbore gun 212′ and to push the pre-assembled wellbore gun 212′ into position within the gun chucks 454c,d of the build assembly 216. Once the pre-assembled wellbore gun 212′ is in position, the drive assembly 326 may disengage the pre-assembled wellbore gun 212′ and return to its original (retracted) position.

As shown in FIG. 6D, with the first gun carrier 217a positioned in the axial gun chuck 454d and the second gun carrier 217a positioned in the rotating gun chuck 454c, the chuck jaws 454e of each gun chuck 454c,d may be extended to grip (or clamp onto) the gun carriers 217a and secure the gun carriers 217a tightly therein.

As shown in FIG. 6E, the rotating gun chuck 454c may rotate the second gun carrier 217a while the axial gun chuck 454d may freely move axially about the build assembly 216. The rotation of the rotating gun chuck 454c causes the second gun carrier 217a to advance along the gun sub 217b and the gun sub 217b to advance along the first gun carrier 217a, thereby tightening the threaded connections therebetween.

As the rotating gun chuck 454c is rotated clockwise, the axial gun chuck 454d may be pulled towards the rotating gun chuck 454c to allow the gun components 236 to be joined. Once the gun components 236 are completely joined, a drive torque will be applied until a preset optimal torque value is achieved. The rotating gun chuck 454c may rotate according to operation parameters, such as rotating speed, applied torque, etc., until a predefined, optimal connection between the first gun carrier 217a, the gun sub 217b, and the second gun carrier 217a is achieved. The process may be repeated to apply additional gun subs 217b and gun carriers 217a to the formed wellbore gun 212, or to create separate wellbore guns 212.

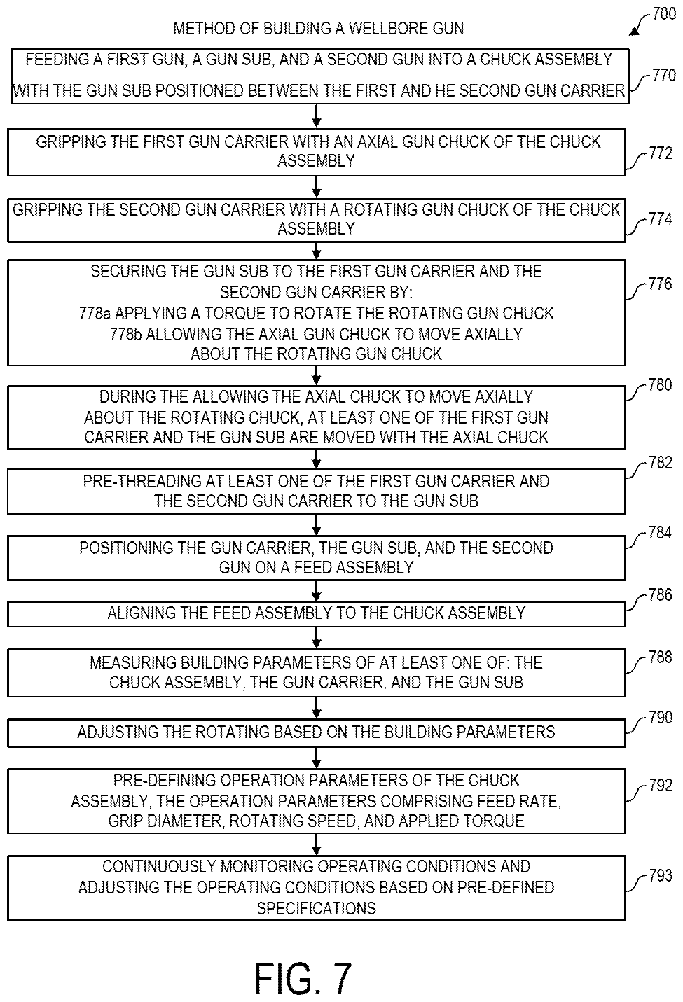

FIG. 7 is a flow chart depicting a method 700 of building a wellbore gun 212. The method 700 involves 770—feeding a first gun carrier, a gun sub, and a second gun into a chuck assembly with the gun sub positioned between the first gun carrier and the second gun carrier, 772—gripping the first gun carrier with an axial gun chuck of the chuck assembly, 774—gripping the second gun carrier with a rotating gun chuck of the chuck assembly, and 776—securing the gun sub to the first gun carrier and the second gun carrier by: 778a—applying a torque to rotate the rotating gun chuck; and 778b—allowing the axial gun chuck to move axially about the rotating gun chuck.

The method 700 may also involve 780—during the allowing the axial chuck to move axially about the rotating chuck, at least one of the first gun carrier and the gun sub are moved with the axial chuck, 782—pre-threading at least one of the first gun carrier and the second gun carrier to the gun sub, 784—positioning the gun carrier, the gun sub, and the second gun on a feed assembly, 786—aligning the feed assembly to the chuck assembly, 788—measuring building parameters of at least one of: the chuck assembly, the gun carrier, and the gun sub, 790—adjusting the rotating based on the building parameters, and/or 792—pre-defining operation parameters of the chuck assembly (the operation parameters comprising feed rate, grip diameter, rotating speed, and applied torque), and/or 793—continuously monitoring operating conditions (e.g., electrical and/or communication signals, sensors, gauges, etc.) and adjusting the operating conditions based on pre-defined specifications (e.g. safety guidelines, client instructions, etc.).

Portions of the method may be performed in various orders, and part or all may be repeated.

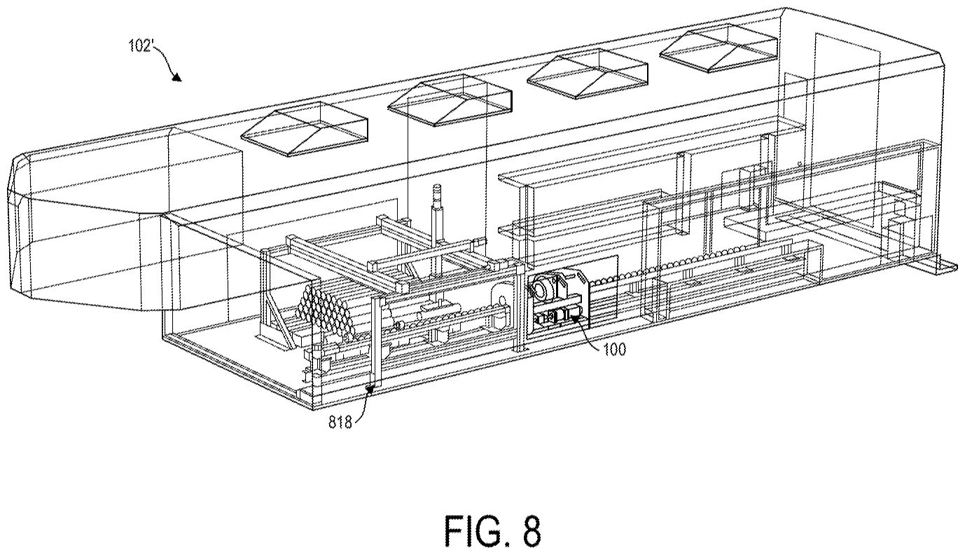

FIG. 8 is a schematic view of the wellbore gun builder 100 with a gantry loader 818 housed within another gun trailer 102′. The gun trailer 102′ may be similar to the gun trailer 102′ for housing and/or transporting the gun builder 100. In this version as shown, the gun trailer 102′ is expanded to house the gantry loader 818 and other device, such as operator stations, storage equipment, computer equipment, personnel, etc. As also shown, this gun trailer 102′ is a stationary unit with no wheel assembly 106 or hitch 110 (FIGS. 1A and B). The wheel assembly 106, hitch 110, and/or other devices may be optionally provided, or the gun trailer 102′ may be carried by a transporter, such as a flatbed trailer. As demonstrated by this view, the gun trailer 102′ may have various shapes, sizes, options, rooms, and/or contents.

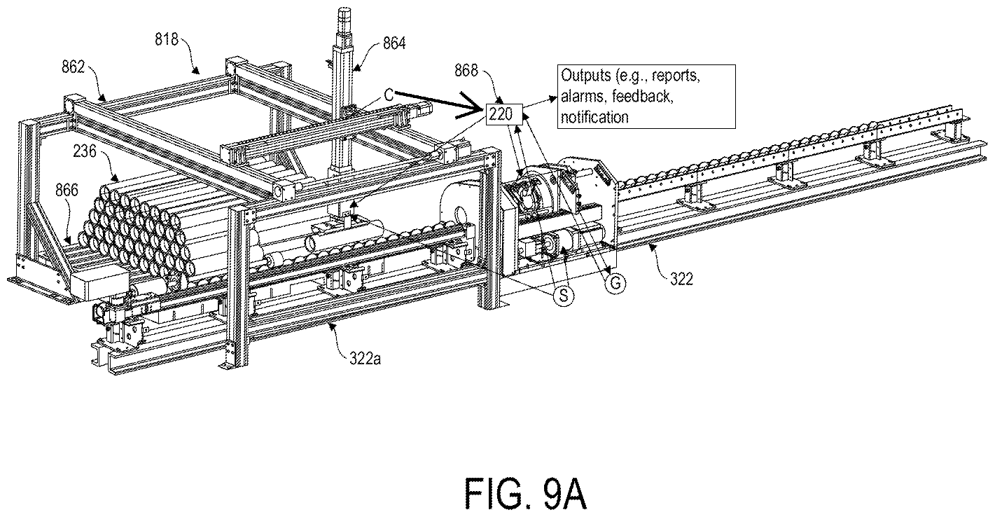

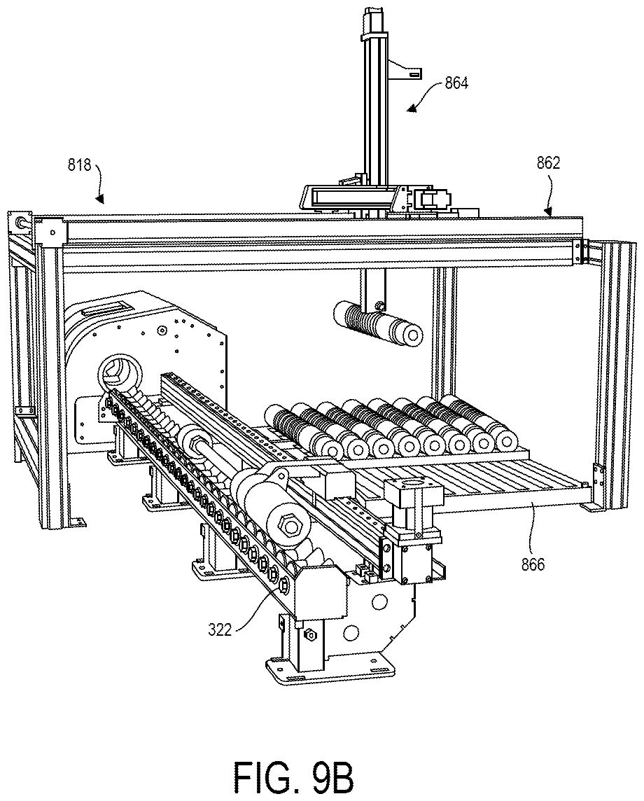

FIGS. 9A and 9B are schematic views of the wellbore gun builder 100 with the gantry loader 818. The gantry loader 818 is positioned about the upstream portion 322a of the conveyor 322. As shown in this example, the gantry loader includes a gantry frame 862 and a gantry driver 864. The gantry frame 862 is secured about the upstream portion 322a of the conveyor 322 with the gantry driver 864 movable positioned thereabout. A gantry pallet 866 is positioned below the gantry frame 862 for storing the gun components 236 for loading by the gantry loader 818 onto the conveyor 322.

As also shown in FIGS. 9A and 9B, the gantry loader 818 is used to load the gun components 236 onto the conveyor. The gantry driver 864 is used to lift the gun components 236 from the pallet 866, translate the gun components 236 along the gantry frame 862, and then release the gun components 236 onto the upstream portion 322a of the conveyor 322. The gantry loader 818 may be provided with devices for controlling of the gantry loader 818.

In the example shown, the gantry loader 818 is coupled to the electronics 220 for operation therewith. The electronics 220 may have software and hardware capabilities for operating the gantry loader 818 and/or monitoring loading operations. Sensors S, gauges G, and cameras C may be provided about the gantry loader 88 to provide data to the electronics 220 and generate the outputs relating to loading alone or in combination with other building operations therefrom. For example, the gantry loader may selectively pick certain gun components 236 from a pallet 866 based on input from an operator 868 that is fed into the electronics 220 as schematically shown. The camera C may be used to verify that the correct gun component 236 is pulled from the pallet 866 and/or that the gun component 236 is placed in the correct orientation for loading onto the conveyor 322.

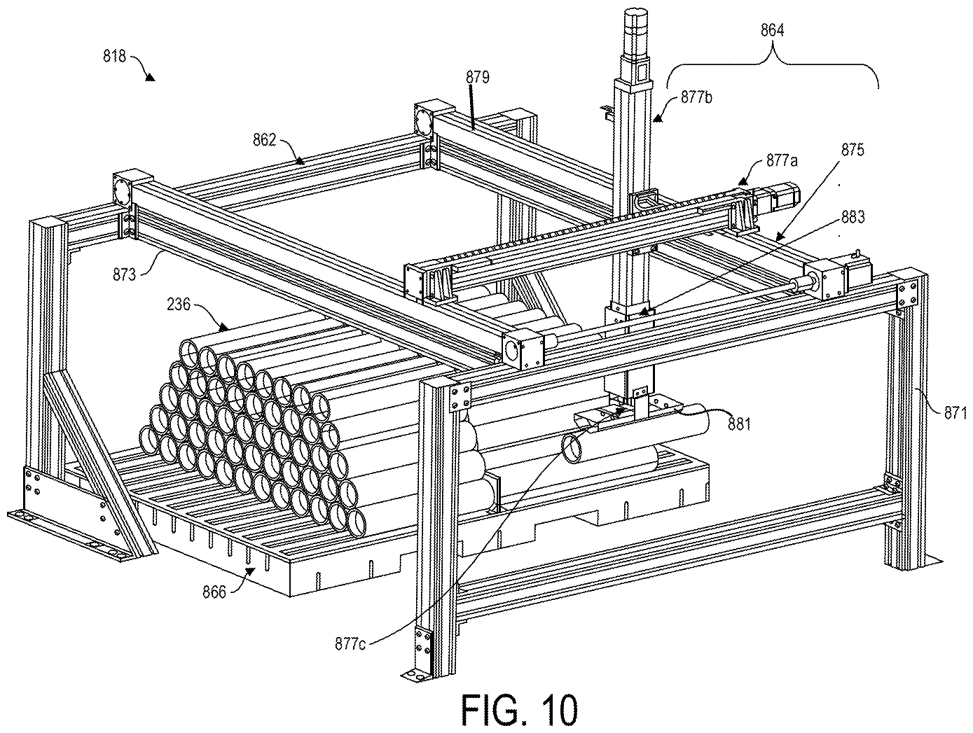

FIG. 10 is a detailed schematic view of the gantry loader 818. As shown in this example, the gantry loader 818 has a frame with vertical legs 871 and horizontal crossbars 873. The vertical legs 871 are vertically supported on the floor with the horizontal crossbars 873 extending therebetween. The vertical legs 871 and the horizontal crossbars 873 are spaced sufficiently apart to provide space for the pallet 866 therebetween. The vertical legs and horizontal crossbars 873 are also configured for placement over the upstream portion 322a of the conveyor 322 (FIGS. 9A and 9B).

The horizontal crossbars 873 have rails 875 thereon. The rails 875 are positioned on the horizontal crossbars 873 to movably support the gantry driver 864 thereon. The gantry driver 864 includes a gantry slider 877a, a gantry lift 877b, and a gantry gripper 877c. The gantry slider 877a is a linear member horizontally positioned about the horizontal crossbars 873. The gantry slider 877a has slider keys 879 spaced apart therealong. Each of the slider keys 879 is receivably connected to one of the rails 875, and is slidably move therealong to allow the gantry slider 877a to translate along the rails 875 in an axial direction.

The gantry lift 877b is a linear member vertically positioned about the gantry slider 877a. The gantry lift 877b may also have a slider key 879 receivably connected to the gantry slider 877a and slidably movable therealong. To translate along the gantry slider 877a in a vertical direction.

The gantry gripper 877c may be secured to a lower end of the gantry lift 877b. The gripper 877c may have a gripper hand 881 capable of attaching to and lifting the gun component 236. The gripper hand 881 may be any device capable of lifting the gun component 236, such as a pneumatic device for applying suction or a magnet for applying a magnetic force to the gun component 236.

The gantry loader 818 may be provided with other devices, such as a gantry motor 883 for moving the gantry slider 877a and the gantry lift 877b, and for activating the gripper 877c to lift and release the gun components 236. The gantry motor 883 may be coupled to the electronics 220, as well as other devices for operation therewith. The gantry motor 883 and/or the gantry loader 818 may be operated in conjunction other components of the gun builder 100 for coordinated operation therewith.

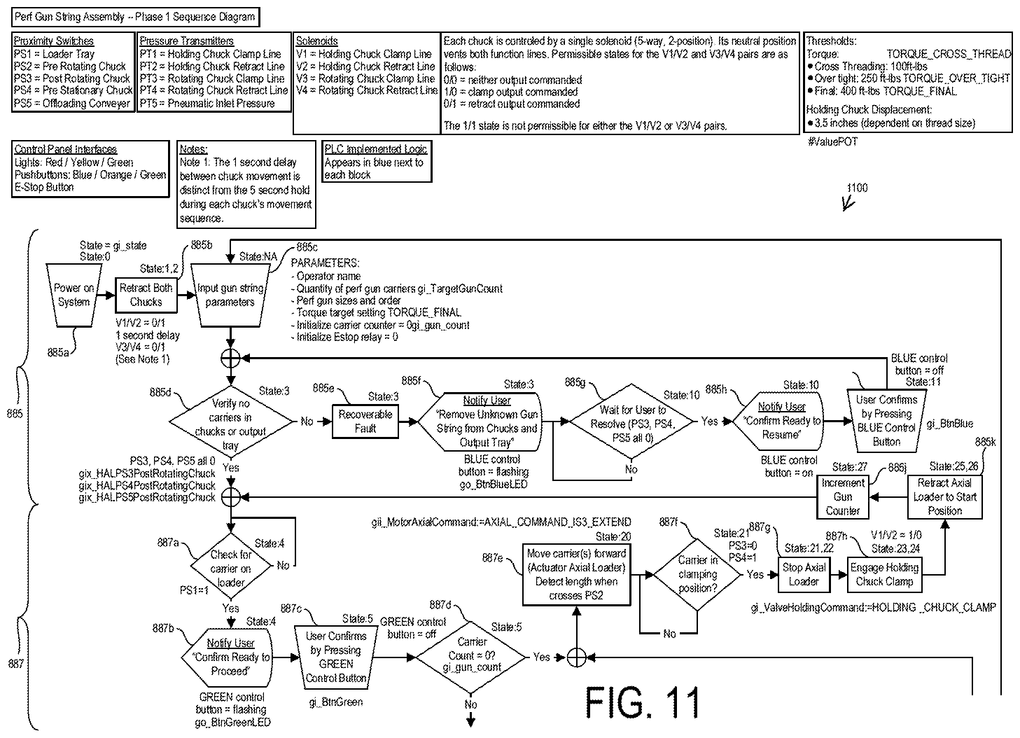

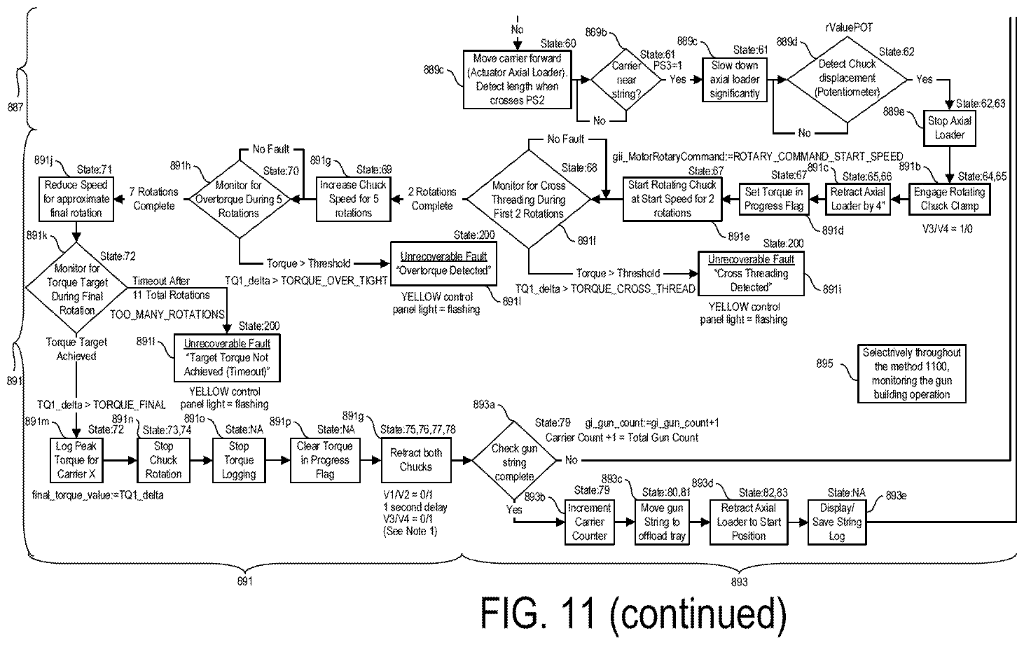

FIG. 11 is a flow chart depicting a method 1100 of performing a gun building operation. This method 1100 shows an example process for monitoring and controlling the assembly of a wellbore gun as it is being built. The method 1100 involves 885—initiating the gun building operation, 887—loading the gun components onto the feed assembly, 889—feeding the gun components into the build assembly, 891—connecting the components in the build assembly, 893—feeding the assembled gun out of the build assembly, and 895 monitoring the gun building operation. This example process may be performed using the gun builder 100 as described herein. This method 1100 may be used with control hardware software (e.g., electronics as described herein) to operate build equipment, such as the loader, the feed assembly, and the build assembly, to perform various build operations. The software may include computer readable medium supported in the hardware (e.g., CPUs) for operating the build equipment.

The 885—initiating the gun building operation involves 885a turning power on to the gun builder, 885b retracting the axial and radial chucks in the build assembly, and 885c inputting gun string parameters. The 885 initiating continues with 885d verifying no carriers (e.g., wellbore guns or gun components) are located in the axial or radial chucks or the feed assembly (e.g., the downstream conveyor or output tray). The 885 initiating continues with 885e indicating a recoverable fault, 885f notifying the user to remove the wellbore gun from the build and feed assemblies (e.g., the axial and radial chucks and the downstream conveyor), 885g monitoring the build assembly and waiting for the user to resolve the fault, 885h notifying the user to confirm the user is ready to resume, and 885i confirming ready to resume by user pressing control button.

The 887—loading the gun components onto the feed assembly involves 887a—checking for a wellbore gun (carrier) on the loader. The checking (887a) may be repeated until a wellbore gun is positioned on the loader. Once a wellbore gun is detected on the loader, the loading 887 continues by 887b notifying the user to confirm ready to proceed, 887c allowing the user to confirm by pressing a control button, and 887c checking for wellbore gun (carrier) count. If yes, the loading 887 continues with 887d moving the wellbore gun forward and detecting a length of the wellbore gun. The loading 887 continues with 887e determining a position of the wellbore gun, 887f stopping the feeder (axial loader), 887e engaging the chuck clamps, 887f retracting the axial gun loader to a start position, and 887g incrementing a gun counter. The loading 887 may be repeated until the wellbore gun count (887c) is no longer zero (0).

The 889—feeding the gun components into the build assembly involves 889a if no a wellbore gun is on the loader, then moving the wellbore gun forward and detecting a length when the wellbore gun passes a certain point, 889b determining if the wellbore gun is near, 889c if so, then slowing down the feeder, and 889d detecting chuck displacement.

The 891—connecting the components in the build assembly involves 891a stopping the feeder if chuck displacement (889d) is detected, 891b—engaging the rotating gun chuck clamp, 891c retracting the axial loader, 891d setting torque in a progress flag, and 891e start rotating gun chuck at a start speed. The 891 connecting continues with 891f monitoring cross threading during the rotating 891e to detect cross threaded and generate a fault 891i if a threshold is not met. Once the threshold is met, the 891 connecting continues with 891f increasing chuck speed for additional rotations and 891g monitoring for overtorque. If a threshold overtorque is detected, then 891h an unrecoverable fault 891l is generated. If no overtorque is detected, then the connecting 891 continues to 891j reducing speed for final rotation and monitoring the torque and 891k monitoring torque during the final rotation. If a targeted torque is not achieved, an unrecoverable fault 891l is generated. If no fault 891k is generated, then the 891 connecting continues to 891m logging peak torque, 891n stopping chuck rotation, 8910 stopping torque logging, 891p clearing torque in progress flag, and 891q retracting both the radial and axial chucks.

The 893—feeding the assembled gun out of the build assembly involves 893a checking if wellbore gun is complete. If not, repeating a portion of the method. If so, then 893b incrementing the wellbore gun counter, 893c moving the wellbore gun to the downstream conveyor or offload tray, 893d retracting the axial gun loader back to its start position, and 893e, displaying or saving a log for the wellbore gun.

The 895 monitoring the gun building operation may be performed throughout the method 1100. The electronics may collect data from the various sensors, gauges, and cameras to determine conditions wherever decisions are made. The monitoring 895 may be used to generate outputs, such as faults (e.g., 885e, 891i, 891l) and a job report based on any issues encountered during operation, how many guns were assembled, who the operator monitoring the gun builder was. The monitoring may also involve tracking inventory usage onsite.

Part or all of the method may be performed in any order, or as needed. Part or all of the methods herein may be performed using hardware (e.g., processors), software (e.g., computer readable medium (transitory or non-transitory)), and or the monitors described herein.

As used herein, “computer readable medium” or “machine-readable storage medium” may include a storage drive (e.g., a hard drive), flash memory, Random Access Memory (RAM), any type of storage disc (e.g., a Compact Disc Read Only Memory (CD-ROM), any other type of compact disc, a DVD, etc.) and the like, or a combination thereof. In some examples, a storage medium may correspond to memory including a volatile (main) memory, such as RAM, where software may reside during runtime, and a secondary memory. The secondary memory can, for example, include a non-volatile memory where a copy of software or other data is stored.

As provided above, examples in the present disclosure may also be directed to a non-transitory computer-readable medium storing computer-executable instructions and executable by one or more processors via which the computer-readable medium is accessed. A computer-readable media may be any available media that may be accessed by a computer. By way of example, such computer-readable media may include random access memory (RAM), read-only memory (ROM), electrically erasable programmable read-only memory (EEPROM), compact disk read-only memory (CD-ROM) or other optical disk storage, magnetic disk storage or other magnetic storage devices, or any other medium that may be used to carry or store desired program code in the form of instructions or data structures and that may be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Note also that the software implemented aspects of the subject matter claimed below are usually encoded on some form of program storage medium or implemented over some type of transmission medium. The program storage medium is a non-transitory medium and may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The claimed subject matter is not limited by these aspects of any given implementation.

Furthermore, examples disclosed herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

This description of preferred embodiments is to be read in connection with the accompanying drawings, which are part of the entire written description of this invention. In the description, corresponding reference numbers are used throughout to identify the same or functionally similar elements. Relative terms such as “horizontal,” “vertical,” “up,” “upper”, “down,” “lower”, “top”, “bottom”, “anterior” and “posterior” as well as derivatives thereof (e.g., “horizontally,” “downwardly,” “upwardly,” etc.) should be construed to refer to the orientation as then described or as shown in the drawing figure under discussion. These relative terms are for convenience of description and are not intended to require a particular orientation unless specifically stated as such. Terms including “inwardly” versus “outwardly,” “longitudinal” versus “lateral” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship.

While the embodiments are described with reference to various implementations and exploitations, it will be understood that these embodiments are illustrative and that the scope of the inventive subject matter is not limited to them. Many variations, modifications, additions and improvements are possible. For example, various combinations of one or more of the features and/or methods provided herein may be used.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter. For example, while certain tools and components (e.g., assemblies) are provided herein, it will be appreciated that various configurations (e.g., shape, order, orientation, etc.) of such tools and/or components may be used. While the figures herein depict a specific configuration or orientation, these may vary. First and second are not intended to limit the number or order.

Insofar as the description above and the accompanying drawings disclose any additional subject matter that is not within the scope of the claim(s) herein, the inventions are not dedicated to the public and the right to file one or more applications to claim such additional invention is reserved. Although a very narrow claim may be presented herein, it should be recognized the scope of this invention is much broader than presented by the claim(s). Broader claims may be submitted in an application that claims the benefit of priority from this application.

What is claimed is:

1. A chuck assembly for assembling a wellbore gun, the chuck assembly comprising:
a chuck housing;
a rotating gun chuck positioned in the chuck housing and rotationally movable thereabout, the rotating gun chuck having a first hole therethrough, the rotating gun chuck comprising rotating chuck jaws radially movable about the first hole in the rotating chuck to selectively grip a portion of the wellbore gun; and
an axial gun chuck positioned in the chuck housing and axially movable thereabout, the axial gun chuck having a second hole therethrough, the axial gun chuck comprising axial chuck jaws radially movable about the second hole in the axial gun chuck to selectively grip another portion of the wellbore gun, the second hole of the axial gun chuck aligned with the first hole of the rotating gun chuck to define a passage for receiving the wellbore gun therethrough; and
wherein the rotating gun chuck is rotationally positioned about the axial gun chuck to selectively rotate the portion of the wellbore gun as the axial gun chuck moves axially about the chuck housing whereby the portion of the wellbore gun is threadedly connected to the another portion of the wellbore gun.

2. The chuck assembly of claim 1, wherein the chuck assembly further comprises a gear assembly rotationally coupled to the rotating gun chuck, the gear assembly comprises gears rotationally driven by a gear motor.

3. The chuck assembly of claim 2, wherein the gears are supported between a gear plate and the chuck housing, the rotating gun chuck positioned about the gear plate.

4. The chuck assembly of claim 1, wherein the chuck assembly further comprises bearings supported in the chuck housing, the axial gun chuck slidably movable along the bearings.

5. The chuck assembly of claim 4, wherein the bearings and the axial gun chuck are supported on a bearing plate.

6. The chuck assembly of claim 1, wherein the chuck assembly further comprises an axial guide supported about the chuck housing, the axial gun chuck slidably movable along the axial guide.

7. The chuck assembly of claim 1, wherein the chuck housing comprises side panels, a back panel and a base, the chuck assembly further comprising a gear plate and a bearing plate parallel to the side panels and extending a distance vertically about the base, the rotating gun chuck connected to the gear plate, the axial gun chuck connected to the bearing plate.

8. The chuck assembly of claim 1, wherein the chuck housing comprises a case with a lid.

9. The chuck assembly of claim 1, further comprises a build unit coupled to the chuck assembly, the build unit comprising a processor to monitor the chuck assembly.

10. The chuck assembly of claim 9, wherein the build unit comprises sensors operatively connected to the chuck assembly to collect build data therefrom.

11. A wellbore gun builder for assembling a wellbore gun, the wellbore gun builder comprising:
the chuck assembly as in claim 1; and
a feed assembly comprising a conveyor positioned about the chuck assembly to selectively feed the wellbore gun through the passage.

12. The wellbore gun builder of claim 11, wherein the conveyor comprises an upstream portion and a downstream portion, the chuck assembly positioned between the upstream portion and the downstream portion.

13. The wellbore gun builder of claim 11, wherein the feed assembly further comprises a linear actuator comprising a belt movably positioned about the conveyor and a drive assembly slidably movable with the belt, the drive assembly comprising a piston engagable with the wellbore gun to drive the wellbore gun along the conveyor.

14. The wellbore gun builder of claim 11, further comprising a loader positioned about the feed assembly to load gun components onto the conveyor.

15. The wellbore gun builder of claim 14, wherein the loader comprises a crane.

16. The wellbore gun builder of claim 14, wherein the loader comprises a gantry loader, the gantry loader comprising a gantry frame positioned about the feed assembly, a gantry driver movably supported about the gantry frame, and a gripper carried by the gantry driver.

17. The wellbore gun builder of claim 16, wherein the gantry driver comprises a gantry slider slidably movably secured to the gantry frame, a gantry lift vertically movable about the gantry slider, the gripper is carried by the gantry lift.

18. The wellbore gun builder of claim 16, wherein the gripper receivably supports portions of the wellbore gun and selectively releases the portions of the wellbore gun onto the feed assembly as the gantry driver moves about the gantry frame.

19. The wellbore gun builder of claim 18, wherein the gripper has a hand to receivably support the portions of the wellbore gun, the hand comprising one of a pneumatic valve and a magnet.

20. The wellbore gun builder of claim 16, wherein the gantry loader further comprises a pallet having a surface to support the portions of the wellbore gun.

21. The wellbore gun builder of claim 16, further comprising a build unit coupled to at least one of the chuck assembly, the feed assembly, and the gantry loader for selectively operation thereof.

22. A method of building a wellbore gun, comprising:
feeding gun components of the wellbore gun into a build assembly by:
feeding a first gun, a gun sub, and a second gun into a chuck assembly with the gun sub positioned between the first gun and the second gun;
gripping the first gun with an axial gun chuck of the chuck assembly; and
gripping the second gun with a rotating gun chuck of the chuck assembly; and
selectively connecting the gun components of the wellbore gun with the build assembly by:
applying a torque to rotate the rotating gun chuck; and
allowing the axial gun chuck to move axially about the rotating gun chuck.

23. The method of claim 22, further comprising during the allowing the axial chuck to move axially about the rotating chuck, at least one of the first gun and the gun sub are moved with the axial chuck.

24. The method of claim 22, further comprising pre-threading at least one of the first gun and the second gun to the gun sub.

25. The method of claim 22, further comprising positioning the first gun, the gun sub, and the second gun on a feed assembly.

26. The method of claim 22, further comprising aligning the feed assembly to the chuck assembly.

27. The method of claim 22, further comprising measuring building parameters of at least one of: the chuck assembly, the gun carrier, and the gun sub.

28. The method of claim 22, further comprising adjusting the rotating based on building parameters.

29. The method of claim 22, further comprising pre-defining operation parameters of the chuck assembly, the operation parameters comprising feed rate, grip diameter, rotating speed, and applied torque.

30. The method of claim 22, further comprising continuously monitoring operating conditions.

31. The method of claim 22, further comprising adjusting operating conditions based on pre-defined specifications.
